(19) United States
(12) Patent Application Publication
(10) Pub. No.: US 2026/0149589 A1
(43) Pub. Date: May 28, 2026

(54) QUANTUM-SAFE ATTRIBUTION FOR BCI-ROBOTIC ENERGY GRIDS

(71) Applicant: George William Bickerstaff, III, Greenwich, CT (US)

(72) Inventor: George William Bickerstaff, III, Greenwich, CT (US)

(21) Appl. No.: 19/453,540

(22) Filed: Jan. 20, 2026

(51) Int. Cl. H04L 9/32; B25J 9/16

(52) U.S. Cl. CPC H04L 9/3221; B25J 9/163

(57) ABSTRACT

A quantum-safe attribution system for brain-computer-interface-directed robotic energy grids enables privacy-preserving verification of neural intent, secure binding of robotic actions to energy outcomes, and automated rollback to maintain safety, regulatory compliance, and resilience in decentralized energy environments.

### TECHNICAL FIELD

The present invention relates to energy grid control systems, autonomous robotics, cryptographic security, brain-computer interfaces, and artificial intelligence governance and, more particularly, to quantum-resistant attribution, trust orchestration, and rollback for neural-directed robotic control of energy grids.

### BACKGROUND

Modern energy grids increasingly rely on autonomous control systems and robotic infrastructure to manage generation, transmission, and distribution of power across decentralized and high-risk environments.

Fusion-derived and advanced energy sources introduce operational complexity that requires rapid coordination among generation assets, robotic agents, and grid dispatch mechanisms.

Brain-computer interfaces allow human operators to supervise or influence grid operations through neural signals, but existing grid systems lack mechanisms to securely attribute neural intent to robotic actions and resulting energy outcomes.

Conventional grid control patents emphasize optimization and resilience but do not address post-quantum security threats, privacy-preserving attribution, or execution-time rollback across neural, robotic, and grid subsystems.

Accordingly, there exists a need for a quantum-safe governance framework that enables neural-directed robotic grid control to operate safely, reversibly, and under regulatory oversight.

### SUMMARY OF THE INVENTION

The invention provides a system and method for quantum-resistant attribution and governance in brain-computer-interface-directed robotic energy grids, cryptographically linking neural intent, robotic execution, and physical energy outcomes.

Neural intent signals are verified and privacy-protected and are bound to robotic grid actions using zero-knowledge and post-quantum cryptographic techniques, enabling verification without disclosure of raw neural data.

Execution-time governance enforces safety constraints and initiates automated rollback of grid actions upon detection of compromised neural signals, robotic faults, or grid instability, ensuring resilient and auditable energy distribution.

### DEFINITIONS (ALPHABETICAL)

Attribution Proof: A cryptographically verifiable record linking neural intent, robotic action, and energy outcome.

BCI (Brain-Computer Interface): A system that acquires neural signals from a human brain and translates them into control directives for computational or physical systems.

BCI Directive: A control instruction derived from a brain-computer interface.

Energy Outcome: A measurable effect on power generation, transmission, or distribution resulting from a control action.

Execution-Time Governance: Enforcement of trust, safety, and authority constraints during control execution.

Neural Privacy Envelope: A cryptographic construct that prevents disclosure of raw neural data while permitting verification.

Post-Quantum Cryptography: Cryptographic techniques resistant to quantum-computing attacks.

Rollback Action: An automated reversal or isolation of a grid control operation.

Robotic Grid Agent: An autonomous or semi-autonomous robotic system operating within an energy grid.

Trust State: A dynamically computed confidence metric assigned to neural, robotic, or grid entities.

### BRIEF DESCRIPTION OF THE DRAWINGS

FIG. 1 illustrates neural intent capture and verification.

FIG. 2 illustrates robotic grid execution and outcomes.

FIG. 3 illustrates quantum-safe attribution.

FIG. 4 illustrates rollback and containment.

FIG. 5 illustrates grid governance interfaces.

### DETAILED DESCRIPTION OF THE INVENTION

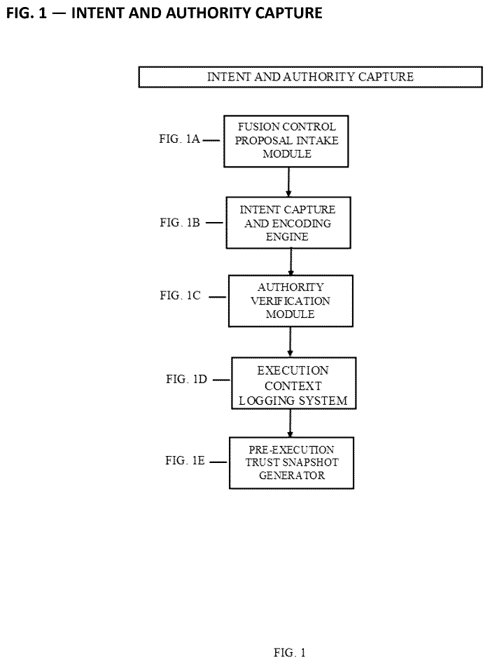

### FIG. 1—Neural Intent Capture

FIG. 1A illustrates neural signal acquisition from a brain-computer interface. Signals are normalized and timestamped. Integrity checks are applied.

FIG. 1B illustrates BCI directive generation from decoded neural signals. Confidence scores are assigned. Low-confidence directives are flagged.

FIG. 1C illustrates privacy encapsulation of the directive. Raw neural data is excluded. Verification remains possible.

FIG. 1D illustrates post-quantum cryptographic signing of the encapsulated directive. Authenticity is preserved. Quantum resistance is enforced.

FIG. 1E illustrates pre-execution authorization based on trust state and grid conditions. Unauthorized directives are rejected. Approved directives proceed.

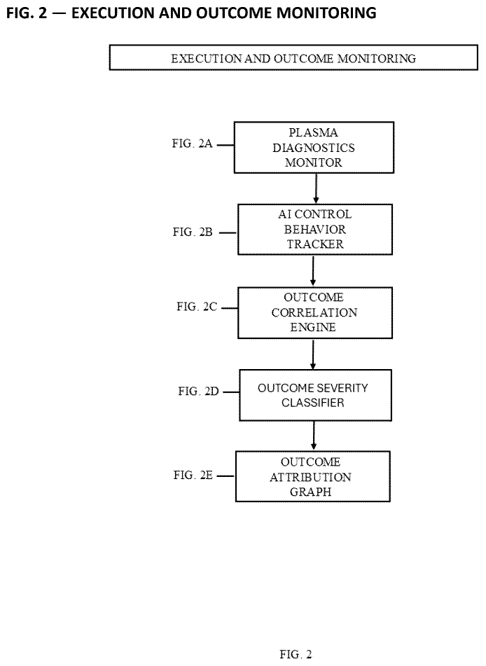

### FIG. 2—Grid Execution

FIG. 2A illustrates robotic agents receiving authorized directives. Execution parameters are constrained. Safety limits are enforced.

FIG. 2B illustrates real-time execution monitoring. Deviations are detected. Trust states are updated.

FIG. 2C illustrates correlation of robotic actions with energy outcomes. Measurements are deterministic. Attribution inputs are captured.

FIG. 2D illustrates anomaly detection within grid responses. Severity levels are assigned. Escalation criteria are evaluated.

FIG. 2E illustrates attribution proof creation. Proofs are immutable. Records persist.

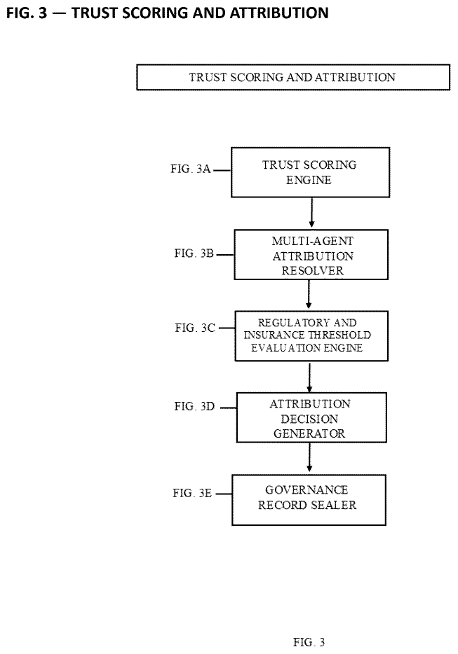

### FIG. 3—Attribution and Trust

FIG. 3A illustrates trust scoring across neural, robotic, and grid subsystems. Scores evolve dynamically. Historical performance is incorporated.

FIG. 3B illustrates zero-knowledge verification of attribution proofs. Verification reveals validity without data exposure. Privacy is maintained.

FIG. 3C illustrates evaluation against regulatory and safety thresholds. Violations trigger governance events. Compliance is logged.

FIG. 3D illustrates multi-stakeholder attribution. Responsibility is apportioned. Jurisdictional context is preserved.

FIG. 3E illustrates sealing and storage of governance records. Tamper resistance is ensured. Auditability is supported.

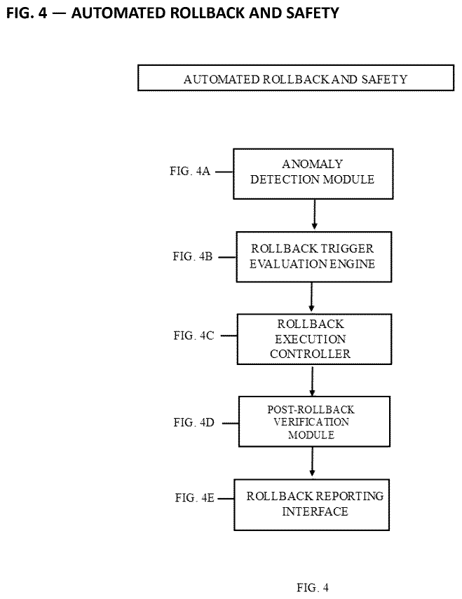

### FIG. 4—Rollback

FIG. 4A illustrates detection of compromised trust or grid instability. Detection is continuous. Alerts propagate immediately.

FIG. 4B illustrates rollback trigger evaluation. Deterministic criteria are applied. Human override is optional.

FIG. 4C illustrates rollback execution, including grid isolation. Containment is prioritized. Safety is restored.

FIG. 4D illustrates post-rollback verification. Trust models are updated. Results are recorded.

FIG. 4E illustrates rollback reporting. attribution details are included. Transmission is secure.

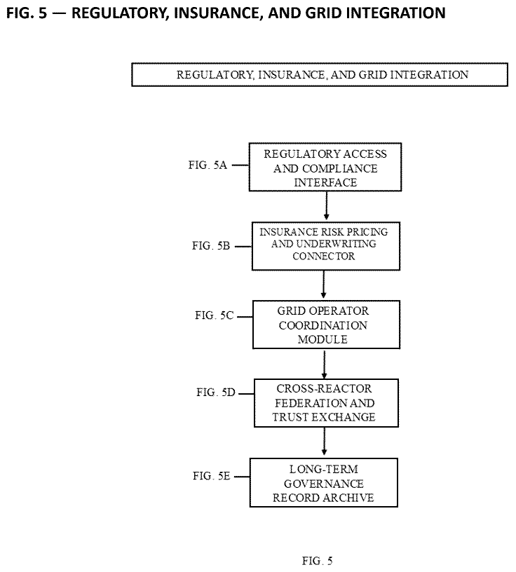

### FIG. 5—Grid Governance

FIG. 5A illustrates role-based governance interfaces. Access is controlled. Actions are logged.

FIG. 5B illustrates coordination across grid nodes. Trust states inform coordination. Consistency is enforced.

FIG. 5C illustrates cross-jurisdiction policy enforcement. Conflicts are resolved. Compliance is maintained.

FIG. 5D illustrates emergency authority reversion. Neural directives are suspended. Safety prevails.

FIG. 5E illustrates archival of governance records. Retention is enforced. Retrieval is auditable.

### EXAMPLE EMBODIMENTS

Example I: A neural-enabled operator issues a directive to rebalance fusion-derived power during peak demand. The directive is privacy-protected and quantum-signed. Upon detection of anomalous grid behavior, rollback isolates the affected segment while preserving attribution.

Example II: In a decentralized grid, multiple robotic agents respond to neural directives from different operators. Outcomes are attributed using zero-knowledge proofs. Regulatory verification occurs without revealing neural data.

1. A quantum-safe attribution system for brain-computer-interface-directed robotic energy grids, comprising: a neural directive capture engine; a privacy-preserving verification module; a trust scoring engine; and a rollback controller configured to reverse grid actions upon detection of compromised trust states.

2. A method for governing neural-directed robotic control of an energy grid, comprising: generating a privacy-protected neural directive;
cryptographically binding the directive to robotic actions; monitoring energy outcomes; and initiating rollback based on trust degradation or grid instability.

3. A non-transitory computer-readable medium storing instructions that cause a system to perform quantum-resistant attribution, execution-time governance, and rollback for BCI-directed robotic energy grids.

4. The system of claim 1, wherein attribution proofs employ zero-knowledge verification.

5. The method of claim 2, wherein cryptographic techniques are resistant to quantum attacks.

6. The system of claim 1, wherein trust states are dynamically updated during grid operation.

7. The method of claim 2, wherein rollback includes isolation of grid segments.

8. The system of claim 1, wherein governance records are immutable and auditable.

9. The computer-readable medium of claim 3, wherein neural data remains undisclosed during verification.

10. The system of claim 1, wherein governance supports multi-stakeholder energy grids.
